(19) United States
(12) Patent Application Publication
(10) Pub. No.: US 2016/0148321 A1
(43) Pub. Date: May 26, 2016

(54) SIMPLIFIED SCREENING FOR PREDICTING ERRORS IN TAX RETURNS

(71) Applicant: HRB Innovations, Inc., Las Vegas, NV (US)

(72) Inventors: Mark Ciaramitaro, Leawood, KS (US); Randy Cox, Lee's Summit, MO (US)

(21) Appl. No.: 14/549,276

(22) Filed: Nov. 20, 2014

(51) Int. Cl. G06Q 40/00

(52) U.S. Cl. CPC G06Q 40/123

(57) ABSTRACT

Embodiments of the invention generally relate to predicting the likelihood of an error in a previously filed tax return. In particular, a set of screening questions is presented to a user that correlate to set of risk factors for an erroneous return. Based on the responses to the screening questions, a likelihood of error and an expected magnitude of error are calculated. Based on the likelihood of error and the expected magnitude of error, an error score and a recommendation of whether to re-prepare and refile an amended tax return is presented.

### BACKGROUND

1. Field

Embodiments of the invention generally relate to predicting the likelihood of an error in a previously filed tax return. In particular, a set of screening questions is presented to a user that correlate to a set of risk factors for an erroneous return. Based on the responses to the screening questions, a likelihood of error and an expected magnitude of error are calculated. Based on the likelihood of error and the expected magnitude of error, a recommendation of whether to re-prepare and refile an amended tax return is presented.

2. Related Art

The correct preparation of a tax return by an individual taxpayer is a notoriously difficult and error-prone task. Furthermore, the penalties for filing an incorrect return can be high. Commercial tax preparation services, such as H&R Block®, offer a variety of services and software to reduce the likelihood of error when filing a tax return for the current tax year.

However, a taxpayer may have filed a previous year's return without the benefit of such a service, and have therefore submitted an incorrect return. As the penalties are significantly lower if the taxpayer subsequently files an amended return correcting the error, it is to the taxpayer's benefit to do so if an error is suspected. However, if no error is in fact present, the effort and cost of re-preparing the amended return is wasted. Accordingly, there is a need for a screening process to determine whether an amended return will be necessary without the effort of actually preparing one.

### SUMMARY

Embodiments of the invention address the above problem by providing an easy-to-complete screening process which provides a likelihood that the effort of preparing and filing an amended return is worthwhile. In a first embodiment, a non-transitory computer readable storage medium having a computer program stored thereon for providing an error score for a taxpayer's previously filed tax return by instructing a processing element to perform the steps of generating a questionnaire predictive of at least one error generally associated with tax returns filed with a government taxing authority, presenting, to a user, the questionnaire for input by the user of at least one response indicative of a tax history of the taxpayer, receiving an input, from the user, of at least one response, and determining, based on the at least one response received from the user, an error score for taxpayer's previously filed tax return.

In a second embodiment, the invention comprises a system for providing an error score for a taxpayer's previously filed tax return, comprising a data store storing a first set of tax-related data known to be associated with erroneous returns, at least one computer executing a prediction engine comprising a statistical analyzer, operable to receive data from the one or more data scores and generate a questionnaire and an error score calculator associated with the questionnaire, a display operable to display the questionnaire and an output of the prediction engine, and an input device, operable to receive a user's responses to the questionnaire and pass the responses to the error score calculator, wherein the error score calculator calculates an error based on the user's responses to the questionnaire.

In a third embodiment, the invention comprises a method of predicting an error in a previously filed tax return, comprising the steps of receiving tax-related data associated with erroneous tax returns, compiling, based on the tax-related data, a plurality of indicators indicating an increased likelihood of error in an associated tax return, generating a questionnaire based on the indicators and a classifier associated with the questionnaire, presenting the questionnaire to a user, receiving tax-related data from the user responsive to the questionnaire, passing the tax-related received from the user data to the classifier, receiving from the classifier an error score for a corresponding tax return, and presenting to the user a recommendation as to preparing an amended return based on the error score.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 depicts an exemplary hardware platform that can form one element of certain embodiments of the invention;

FIG. 2 depicts a system in accordance with embodiments of the invention;

FIG. 3 depicts a flowchart presenting the operation of a method in accordance with embodiments of the invention; and

FIGS. 4(a)-4(c) depict a series of views of the graphical user interface presented to the user of the system.

The drawing figures do not limit the invention to the specific embodiments disclosed and described herein. The drawings are not necessarily to scale, emphasis instead being placed upon clearly illustrating the principles of the invention.

### DETAILED DESCRIPTION

The subject matter of embodiments of the invention is described in detail below to meet statutory requirements; however, the description itself is not intended to limit the scope of claims. Rather, the claimed subject matter might be embodied in other ways to include different steps or combinations of steps similar to the ones described in this document, in conjunction with other present or future technologies. Minor variations from the description below will be obvious to one skilled in the art, and are intended to be captured within the scope of the claimed invention. Terms should not be interpreted as implying any particular ordering of various steps described unless the order of individual steps is explicitly described.

The following detailed description of embodiments of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of embodiments of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate reference to “one embodiment” “an embodiment”, or “embodiments” in this description do not necessarily refer to the same embodiment and are also not mutually exclusive unless so stated and/or except as will be readily apparent to those skilled in the art from the description. For example, a feature, structure, or act described in one embodiment may also be included in other embodiments, but is not necessarily included. Thus, the technology can include a variety of combinations and/or integrations of the embodiments described herein.

Embodiments of the invention may be embodied as, among other things a method, system, or set of instructions embodied on one or more computer-readable media. Computer-readable media include both volatile and nonvolatile media, removable and nonremovable media, and contemplate media readable by a database. For example, computer-readable media include (but are not limited to) RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data temporarily or permanently. However, unless explicitly specified otherwise, the term “computer-readable media” should not be construed to include physical, but transitory, forms of signal transmission such as radio broadcasts, electrical signals through a wire, or light pulses through a fiber-optic cable. Examples of stored information include computer-useable instructions, data structures, program modules, and other data representations.

Embodiments of the invention address the above-described problem by providing an easy-to-complete screening process which provides a likelihood that the effort of preparing and filing an amended return is worthwhile. In a first embodiment, a non-transitory computer readable storage medium having a computer program stored thereon for providing an error score for a taxpayer's previously filed tax return by instructing a processing element to perform the steps of generating a questionnaire predictive of at least one error generally associated with tax returns filed with a government taxing authority, presenting, to a user, the questionnaire for input by the user of at least one response indicative of a tax history of the taxpayer, receiving an input, from the user, of at least one response, and determining, based on the at least one response received from the user, an error score for taxpayer's previously filed tax return.

In a second embodiment, the invention comprises a system for providing an error score for a taxpayer's previously filed tax return, comprising a data store storing a first set of tax-related data known to be associated with erroneous returns, at least one computer executing a prediction engine comprising a statistical analyzer, operable to receive data from the one or more data scores and generate a questionnaire and an error score calculator associated with the questionnaire, a display operable to display the questionnaire and an output of the prediction engine, and an input device, operable to receive a user's responses to the questionnaire and pass the responses to the error score calculator, wherein the error score calculator calculates an error based on the user's responses to the questionnaire.

In a third embodiment, the invention comprises a method of predicting an error in a previously filed tax return, comprising the steps of receiving tax-related data associated with erroneous tax returns, compiling, based on the tax-related data, a plurality of indicators indicating an increased likelihood of error in an associated tax return, generating a questionnaire based on the indicators and a classifier associated with the questionnaire, presenting the questionnaire to a user, receiving tax-related data from the user responsive to the questionnaire, passing the tax-related received from the user data to the classifier, receiving from the classifier an error score for a corresponding tax return, and presenting to the user a recommendation as to preparing an amended return based on the error score.

It should be appreciated that the tax information discussed herein relates to a particular taxpayer, although a user of the invention may be the taxpayer or a third party operating on behalf of the taxpayer, such as a professional tax preparer (“tax professional”) or an authorized agent of the taxpayer. Therefore, use of the term “taxpayer” herein is intended to encompass either or both of the taxpayer and any third party operating on behalf of the taxpayer. Additionally, a taxpayer may comprise an individual filing singly, a couple filing jointly, a business, or a self-employed filer.

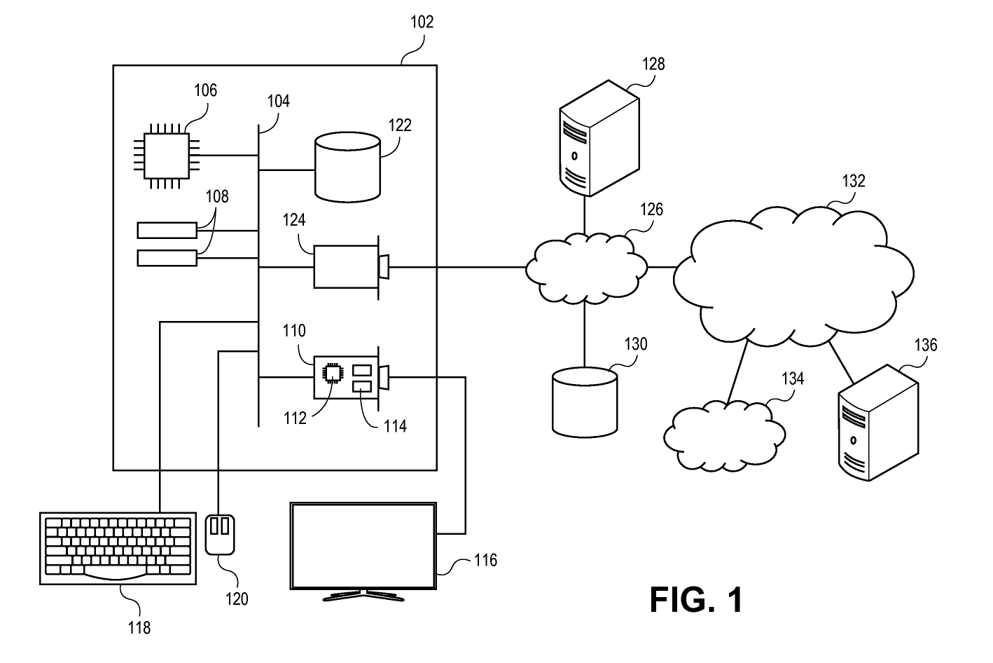

Turning first to FIG. 1, an exemplary hardware platform that can form one element of certain embodiments of the invention is depicted. Computer 102 can be a desktop computer, a laptop computer, a server computer, a mobile device such as a smartphone or tablet, or any other form factor of general- or special-purpose computing device. Depicted with computer 102 are several components, for illustrative purposes. In some embodiments, certain components may be arranged differently or absent. Additional components may also be present. Included in computer 102 is system bus 104, whereby other components of computer 102 can communicate with each other. In certain embodiments, there may be multiple busses or components may communicate with each other directly. Connected to system bus 104 is central processing unit (CPU) 106. Also attached to system bus 104 are one or more random-access memory (RAM) modules.

Also attached to system bus 104 is graphics card 110. In some embodiments, graphics card 104 may not be a physically separate card, but rather may be integrated into the motherboard or the CPU 106. In some embodiments, graphics card 110 has a separate graphics-processing unit (GPU) 112, which can be used for graphics processing or for general purpose computing (GPGPU). Also on graphics card 110 is GPU memory 114. Connected (directly or indirectly) to graphics card 110 is display 116 for user interaction. In some embodiments no display is present, while in others it is integrated into computer 102. Similarly, peripherals such as keyboard 118 and mouse 120 are connected to system bus 104. Like display 116, these peripherals may be integrated into computer 102 or absent. Also connected to system bus 104 is local storage 122, which may be any form of computer-readable media, and may be internally installed in computer 102 or externally and removeably attached.

Finally, network interface card (NIC) 124 is also attached to system bus 104 and allows computer 102 to communicate over a network such as network 126. NIC 124 can be any form of network interface known in the art, such as Ethernet, ATM, fiber, Bluetooth, or Wi-Fi (i.e., the IEEE 802.11 family of standards). NIC 124 connects computer 102 to local network 126, which may also include one or more other computers, such as computer 128, and network storage, such as data store 130. Generally, a data store such as data store 130 may be any repository from which information can be stored and retrieved as needed. Examples of data stores include relational or object oriented databases, spreadsheets, file systems, flat files, directory services such as LDAP and Active Directory, or email storage systems. A data store may be accessible via a complex API (such as, for example, Structured Query Language), a simple API providing only read, write and seek operations, or any level of complexity in between. Some data stores may additionally provide management functions for data sets stored therein such as backup or versioning. Data stores can be local to a single computer such as computer 128, accessible on a local network such as local network 126, or remotely accessible over Internet 132. Local network 126 is in turn connected to Internet 132, which connects many networks such as local network 126, remote network 134 or directly attached computers such as computer 136. In some embodiments, computer 102 can itself be directly connected to Internet 132.

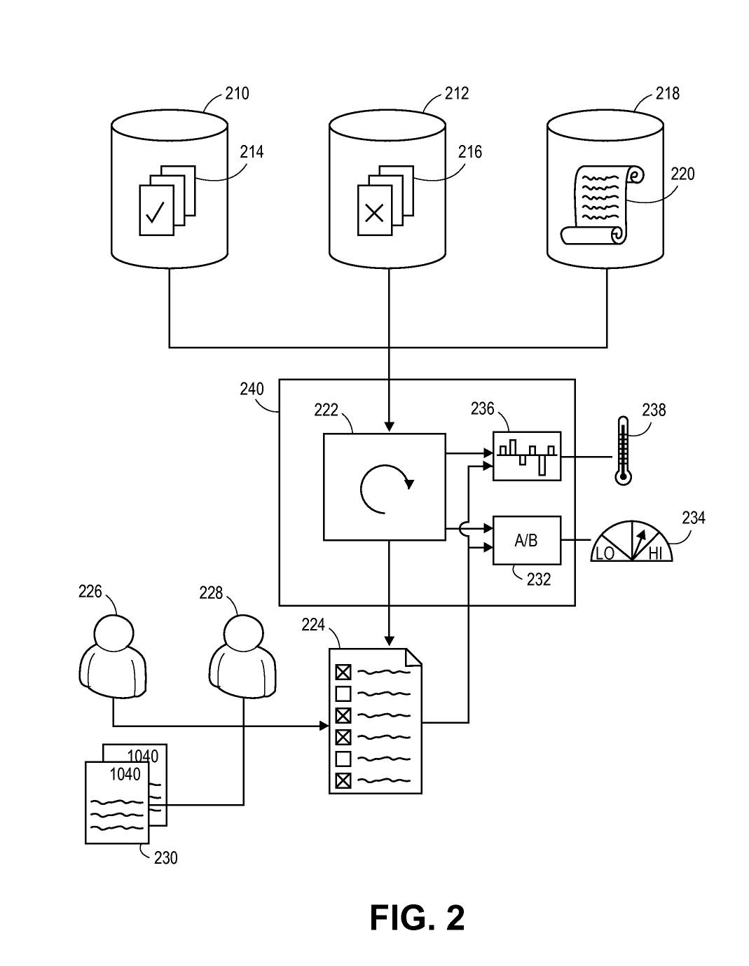

Turning now to FIG. 2, a system in accordance with embodiments of the invention is depicted. Initially present are databases 210 and 212 containing, respectively, correct returns 214 and erroneous returns 216. In some embodiments, databases 210 and 212 may be combined into a single database with a flag indicating whether each return is correct or erroneous. In some embodiments, databases 210 and 212 also contain supplementary tax-related information relating to the return, the taxpayer, or the tax preparer. Each correct return 214 or incorrect return 216 also contains a plurality of tax-related information as well.

Also initially present is a third database 218 containing current and historical tax code information 220. In some embodiments, database 218 can be the same database as database 210 and/or 212. Such information can be useful if, for example, a change in the tax laws retroactively changes a taxpayer's tax liability. Similarly, a newly added tax law may allow a prior return to be amended to take advantage of it. Of course, a person of skill in the art will appreciate that the first year a tax law goes into effect is the first tax year for which the law is applicable or effective and not necessarily the year the law was passed by a rule-making authority.

Prediction engine 240 comprises statistical analyzer 222, classifier 232, and magnitude estimator 236. In some embodiments, all of the components of the prediction engine run on the same computer. In other embodiments, statistical analyzer 222 is co-located with databases 210, 212, and 218, and classifier 232 and magnitude estimator 236 are run on the computer of tax professional 228 or taxpayer 226. A person of skill in the art will appreciate that many different arrangements and distributions of these components is possible within the scope of the invention.

Information from database 210, database 212, and database 218 is analyzed by statistical processor 222, with the goal of identifying traits commonly found in incorrect returns 216 and uncommonly found in correct returns 214. A person of skill in the art will appreciate that such a calculation, particularly on a large data set, is only possible with the aid of computer-assisted statistical techniques such as multivariate and/or univariate analysis.

For example, discriminant function analysis can be used to predict a categorical dependent variable (here, whether a return is correct or erroneous) based on a one or more continuous independent predictor variables (here, the various pieces of tax information stored in databases 210, 212 and/or 218). Discriminant analysis can be used in this application because the categories are known a priori. In discriminant function analysis, each potential discrimination function is a linear combination of one or more of the predictor variables, creating a new latent variable associated with that function. Each potential discrimination function is then given a discrimination score, based on how well it predicts group placements, and a best discrimination function is then selected. However, the objective of statistical processor 222 at this point is not to directly categorize a particular return as correct or erroneous, but rather to generate a small yet robust set of predictors. This limitation on predictor set size can be implemented either a priori, by limiting the potential discrimination functions to those based on a limited number or predictor variables, or ex post facto, by first selecting a discrimination function and then restricting it to those predictor variables with the largest eigenvalues. Those predictor values giving the best discrimination function, limited if necessary to those with the largest eigenvalues, then become the indicators.

In another embodiment, logistic regression is used in place of (or in conjunction with) discriminant function analysis. Unlike discriminant function analysis, where the predictor variables can be continuous or binary, logistic regression operates on binary (or multinomial) predictor variables only. Certain sources of tax-related information are inherently binary in nature (for example, whether or not deductions were itemized), and continuous sources of tax-related information can be made binary or multinomial by supplying one or more threshold values. While discriminant function analysis generally has higher predictive power when its assumptions are met, logistic regression has fewer assumptions and may therefore be useful in cases where discriminant function analysis is not. Furthermore, the use of binary predictor variables allows them to easily converted to yes-or-no screening questions. In logistic regression, a weighted sum of some or all of the predictor variables is passed as an argument to the logistic function:

F(x)=1/1+e^{-(b}^{₀}^{+x}^{₁}^{b}^{₁}^{+x}^{₂}^{b}^{₂}^{+ . . . )} Eqn. 1:

Because the range of the logistic function is the interval between 0 and 1, the resulting value can be used as a probability that the return in question is erroneous if care is taken to assign appropriate values to the predictor variables. Again, the goal is to generate a small yet robust set of predictors, so an appropriate set of predictors xᵢ must be chosen before the regression coefficients bᵢ are computed. The set of predictors giving the most accurate fit then become the indicators.

Other statistical or non-statistical techniques for classifying returns as likely correct or likely incorrect can also be used. For example, if indicators are selected to be more likely present in incorrect returns than in correct returns, a simple count of such red flags can be used. One of skill in the art will appreciate that larger data sets (i.e., larger collections of correct returns 214 and incorrect returns 216) will provide for the selection of fewer predictor variables giving more accurate prediction of return accuracy, as will including additional sources of tax-related information. It will also be appreciated that, as additional data is added to the sets of correct returns 214, erroneous returns 216, and tax code information 220, and as discovered errors cause previously correct returns to be reclassified as incorrect, the best indicators may change. Accordingly, statistical processor 222 may regularly re-calculate an optimal set of indicators based on the current data.

The selected set of indicators is then used to generate a screening questionnaire 224 and a corresponding classifier 226. In some embodiments, multiple questionnaires may be generated (either from the same set of indicators or different indicators) for different users and/or taxpayers. For example, a tax professional screening a business might be presented with a different questionnaire than an individual self-screening. In some embodiments, the generation of screening questions from indicators is automated. For example, if the indicator is “received retirement income,” the question “Have you received retirement income in the past year?” could be automatically generated.

Once screening questionnaire 224 has been generated, it is presented to taxpayer 226. In some embodiments, this is a self-screening process where taxpayer 226 completes the questionnaire themselves and the results are presented directly to them. In another embodiment, tax professional 228 completes the questionnaire on behalf of taxpayer 226 following an interview. In yet another embodiment, questionnaire 224 is partially or totally prepopulated on the basis of taxpayer 226's prior year tax return 230 and presented to taxpayer 226 for completion and/or confirmation. In still another embodiment, the questionnaire is automatically completed solely on the basis of information contained in tax return 230. In yet other embodiments, a current tax year tax return is used instead of (or in addition to) prior year tax return 230 to complete questionnaire 224. In some embodiments, questionnaire 224 relates to a particular tax year, such as the preceding tax year. In other embodiments, questionnaire 224 includes questions relating to more than one tax year, and determines the most relevant tax year automatically or through follow-up questions.

Once questionnaire 224 has been completed by taxpayer 226 and/or tax professional 228, the results are passed back to prediction engine 240, where classifier 232 can be applied to the resulting data to determine a likelihood of error 234 for the corresponding prior year tax return. In some embodiments, likelihood of error 234 is a binary value such as “needs second look”/“does not need second look.” In other embodiments, likelihood of error 234 is a series of discrete values such as “Low”/“Medium”/“High.” In still other embodiments, likelihood of error 234 is a probability value that the corresponding prior year tax return is erroneous.

In some embodiments, statistical analyzer 222 additionally generates a magnitude estimator 236, which calculates an estimated sign and magnitude of an error based on expected correction values corresponding to the indicators selected for inclusion on questionnaire 224. In some embodiments, each expected correction value is the expected change in total tax liability for returns with the corresponding indicator. In some such embodiments, this is calculated by statistical analyzer 222 as a part of determining the most significant indicators, by evaluating the contribution of each indicator to the total error in tax liability in each of erroneous returns 216. In other embodiments, the expected correction value is the average change in tax liability over all of erroneous returns 216 where that indicator is present. In still other embodiments, certain indicators (such as missed or mistakenly claimed tax credits) will have known correction values. Other ways of calculating expected correction for each indicator will be immediately present to one of skill in the art after reading this disclosure, and different calculations can be employed for different indicators.

In those embodiments where magnitude estimator 236 is also created, expected magnitude of error 238 can also be determined. In some embodiments, this is done by summing together those expected correction values, positive or negative, corresponding to those indicators that questionnaire 224 indicates are present. In other embodiments, only positive or only negative expected correction values are used. In still other embodiments, likelihood of error 234 and expected magnitude of error 238 are calculated together by a single instrumentality acting as both classifier 232 and magnitude estimator 236 (as, for example, when a multiple regression analysis is utilized by statistical analyzer 222) and a single composite error score is presented. For the sake of clarity, positive numbers will be used herein to represent an increase in tax liability and negative numbers to represent a corresponding decrease; however, one of skill in the art will recognize that a different convention could easily be used.

Given the information of likelihood of error 234 and expected magnitude of error 238, taxpayer 226 or tax professional 228 can then make an informed decision as to whether to prepare an amended return. For example, a high likelihood of error in combination with any positive expected magnitude of error may indicate that an amended return should be prepared, while a sufficiently small negative expected magnitude of error may indicate that any reduction in tax liability, regardless of its likelihood, may be less than the costs associated with preparing the amended return. In some embodiments, the process of recommending whether to prepare an amended return may be automated and carried out by the system as well.

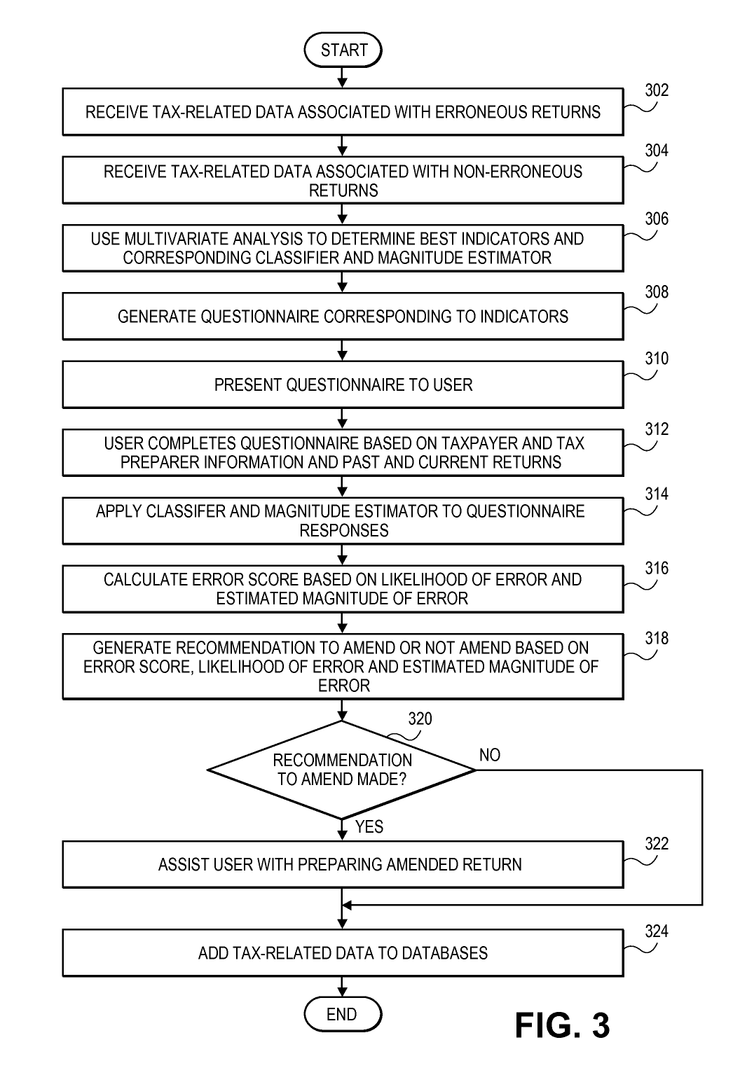

Turning now to FIG. 3, a flowchart presenting the operation of a method in accordance with embodiments of the invention is depicted. The method begins at step 302, where prediction engine 240 receives a set of tax-related data associated with a set of tax return known to contain errors. In some embodiments, this data comes from filed returns that were subsequently re-prepared and found to contain errors. In other embodiments, it comes from returns which have been previously classified as erroneous, either by the invention or otherwise. In still other embodiments, this data also includes data associated with returns selected for audit by a government taxing authority, even if the audit subsequently found them to be correct. It is an advantage of the invention that it can use the tax-related data it gathers for returns that are subsequently confirmed to be correct or erroneous to flag additional returns as requiring re-evaluation. In this way, the more data is gathered, the more accurate classification can be.

Next, at step 304, tax-related data associated with tax returns not known to be erroneous is received by prediction engine 240. In some embodiments, this data can be simply from those all those returns that have not been previously determined to contain an error. In other embodiments, this data is from those returns that have been rechecked and confirmed to be correct. In still other embodiments, this data is from those returns that have some indicia of correctness, such as having been prepared by a tax professional rather than self-prepared. In yet other embodiments, a mix of these sources is used. In some such embodiments, data is weighted in proportion to the likelihood that the corresponding return is free of errors. Further, additional data can be added to both the tax-related data associated with erroneous returns and the tax-related data associated with returns not known to be erroneous. In some embodiments, this is done based on an analysis of tax returns for a prior tax year. In other embodiments, this is done incrementally as additional returns are classified as erroneous or non-erroneous.

Processing the proceeds at step 306 where statistical techniques such as multivariate analysis are used to determine a set of indicators for predicting whether an unclassified return contains at least one error. Any manner of statistical techniques can be employed for this purpose, including complex techniques such as discriminant function analysis and logistic regression, discussed above, and simple techniques such as counting the number of returns in each category that do or do not include a particular indicator. Because statistical data analysis is an extensive field, other techniques are not discussed for reasons of brevity; however, all techniques now known or hereafter invented are contemplated as being within the scope of the invention. For further discussion, the reader is referred to a text covering these data analysis techniques, such as Multivariate Data Analysis, Seventh Edition by Hair, Jr., et al., which is hereby incorporated by reference.

The results of such this analysis include a set of indicators and a classifier. Any indicator can be any binary or continuous element of tax-related data associated with a taxpayer, tax return, or tax code, as discussed above, or a combination of multiple pieces of data. Continuous indicators can be converted to binary indicators through the use of a computed or manually selected threshold. The classifier can be any function of the chosen indicator variables that returns a binary or continuous result indicating the likelihood that a return corresponding to the input values of the indicator variables contains at least one error. In the event that the classifier produces a continuous output variable, a threshold or series of thresholds may also be produced to categorize returns.

In some embodiments, the analysis additionally produces a magnitude estimator. Like the classifier, the magnitude estimator is a function of the indicator variables. Generally, however, the classifier estimates the probability of the error, while the magnitude estimates a monetary amount associated with any error present. Thus, for example, the classifier may indicate that there is a 50% chance that a particular return has an error, while the magnitude estimator may indicate that the error, if present, would result in an additional $1,000 in tax liability (or an additional $1,000 refund due). It may be the case that multiple indicators associated with different error amounts are present. In such a case the magnitude estimator may combine the associated error amounts or present them separately. In some embodiments, magnitudes may not be calculated separately for each potential error, but rather on an indicator-by-indicator basis, where indicators may be joint predictors of a single error or independent predictors of multiple errors.

Next, at step 308, a questionnaire is generated corresponding to the indicators determined in step 306. Here, the goal of the questionnaire is to determine which of the indicators apply to the return to be evaluated. In some embodiments, a question is created for each indicator. In other embodiments, multiple indicators are combined into a single question. In still other embodiments, indicators are broken into multiple questions (for example, an indicator referring to any member of a taxpayer's household could be broken down into questions regarding the taxpayer, the taxpayer's spouse, the taxpayer's dependents, etc.) Since these modified questions become tax-related data for the associated tax return, indicators can gradually become broader or more narrow as necessary to provide the most accurate results.

In some embodiments, the questionnaire may be automatically generated based on the indicators, as discussed above. In other embodiments, indicators may be associated with past questionnaires and accordingly already have questions associated with them. In still other embodiments, a tax professional or other expert prepares questions corresponding to the indicators previously determined.

As described previously, new data can be regularly added to databases 210, 212, and 218. Accordingly, steps 302, 304 and 308 can be re-run to ensure that the questionnaire, classifier and magnitude estimator reflect the most current set of data. In some embodiments this will happen periodically; in other embodiments, it will happen when new data is added; in still other embodiments it will happen whenever a questionnaire is to be presented to a user. This presentation happens at step 310. As described above, the user to whom the questionnaire is presented may be a tax preparer or a taxpayer. In some embodiments, all of the questions relate to a single tax year. In some such embodiments, the tax year is the immediately prior tax year. In other embodiments, the questions may relate to multiple tax years, with further questions to determine the relevant year for a positive response.

Next, at step 312, the questionnaire is completed by the user. In some embodiments, the questionnaire is instead automatically completed based on a current or prior year's tax return provided by the taxpayer or an automated system, or based on another source of data. In other embodiments, the questionnaire may have portions to be completed by the taxpayer, portions to be completed by the tax preparer, and portions to be automatically completed based on a current or prior year's tax return. Where the responses made by the taxpayer or tax preparer, they can be entered directly into a computer, or made on paper and subsequently manually or automatically be transferred to computer storage.

Processing then proceeds at step 314, where the classifier is applied to the results of the questionnaire to obtain a likelihood of error. In some embodiments, this likelihood of error is a probability that the corresponding return contains at least one error. In other embodiments, the likelihood is a categorization of the return into one of a plurality of predefined categories. In some such embodiments, the categorization may also be accompanied by a confidence metric. In embodiments where the magnitude estimator was also generated at step 306, it is also applied to the results to obtain an expected magnitude of error. In some embodiments, prediction engine 240 generates a single combined classifier and magnitude estimator that produces a single value or multiple values.

Next at step 314, the results obtained in step 316 are used to calculate an error score. In some embodiments where the classifier produces a probability of error and the magnitude estimator produces an expected magnitude of error, this can be done by simply multiplying the probability of error by the expected magnitude of the error. In other embodiments, the error score may simply be a numerical output of the classifier, such as the probability of error. In yet other embodiments, the error score is calculated using the output of the classifier and whether the expected error is negative or positive. In general, the error score may be any function of the outputs of classifier 232 and/or magnitude estimator 236, howsoever calculated.

At step 318, a recommendation to prepare an amended return or not to prepare an amended return is generated, based on the calculated error score, the likelihood of error, and/or the magnitude of error. Different embodiments may generate this recommendation differently. For example, any expected increase in tax liability could be cause to recommend amending, to avoid interest and penalties associated with underpayment. In some embodiments, any likelihood of error above a predetermined threshold will cause a recommendation to prepare an amended return to be generated as well, regardless of any expected magnitude of the associated error. In other embodiments, if a sufficiently small decrease in tax liability is expected, a recommendation not to prepare an amended return may be generated. For example, this may be the case if the cost of preparing and filing the amended return would be larger than a refund due. Alternatively, if the probability of error is sufficiently small, then it may be recommended not to prepare an amended return even if expected magnitude of error is large. In some embodiments, this recommendation is made automatically based on the calculated error score, the likelihood of error, and/or the magnitude of error. In other embodiments, some or all of these factors are presented to the tax preparer who offers the recommendation.

At decision 320, it is determined whether a recommendation to amend was made. If a recommendation to amend was made, processing proceeds to step 322, where the system assists the user with preparing the amended return. In some embodiments, this may take the form of indicating the possible error to the user so that an amended return can be prepared in the conventional manner known in the art. In other embodiments, additional questions are provided to the taxpayer and/or tax preparer to determine if an error is in fact present. In still other embodiments, a partially or fully completed amended return is presented to the user for review and verification, based on a corresponding prior year tax return and information gathered from the questionnaire. In yet other embodiments, assisting the user in preparing the tax return can involve more than one of these by, for example, presenting the user with an amended return with the correct information pre-populated from an original return, and asking additional questions to populate the information correcting the error. In some embodiments, the amended return can be presented to the user for an electronic signature and automatically filed with the government tax authority.

At this point, or if it was determined at decision 320 that no recommendation to amend was made, processing continues at step 324, where the tax-related information pertaining to the return being evaluated is added to database 210 or database 212. If it was determined during the process of preparing the amended return that no error was in fact present, the tax-related data can be added to database 210. If it was determined that an error was present, the tax-related data and magnitude of the error can be added to database 212. In some embodiments, if a recommendation to amend was not made, the tax-related data can also be added to database 210. In some such embodiments, data where an amended return was prepared and no error was found is added to database 210 with a higher indication of confidence (and is accordingly weighted more heavily by statistical analyzer 222) than data where no amended return was prepared. At this point, processing terminates.

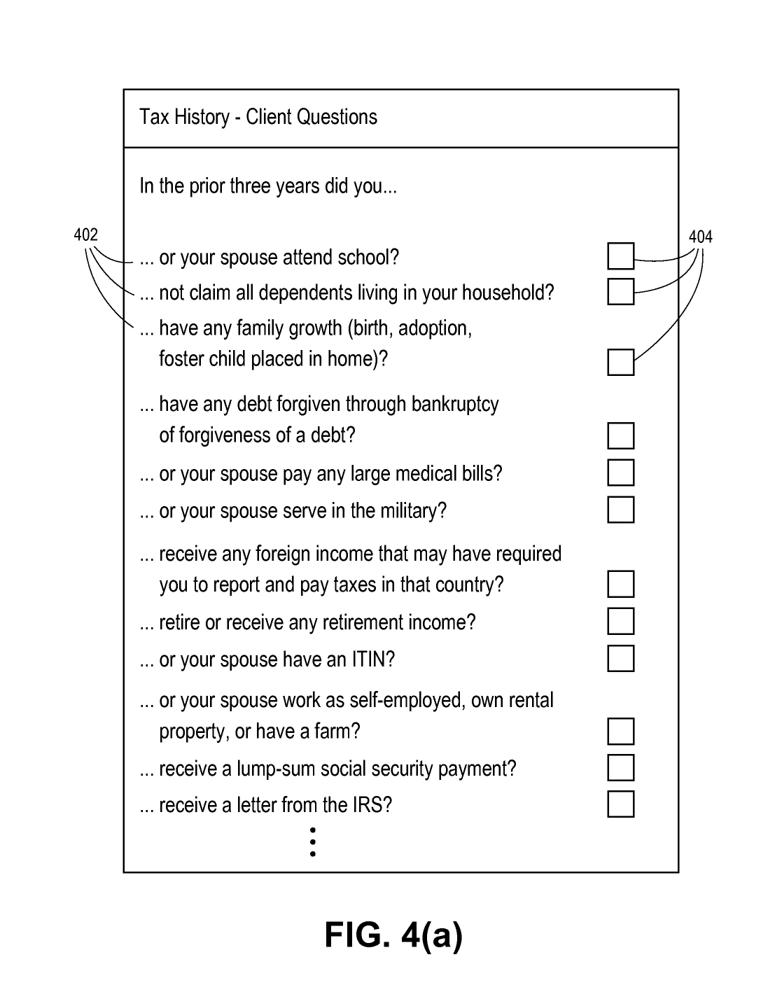

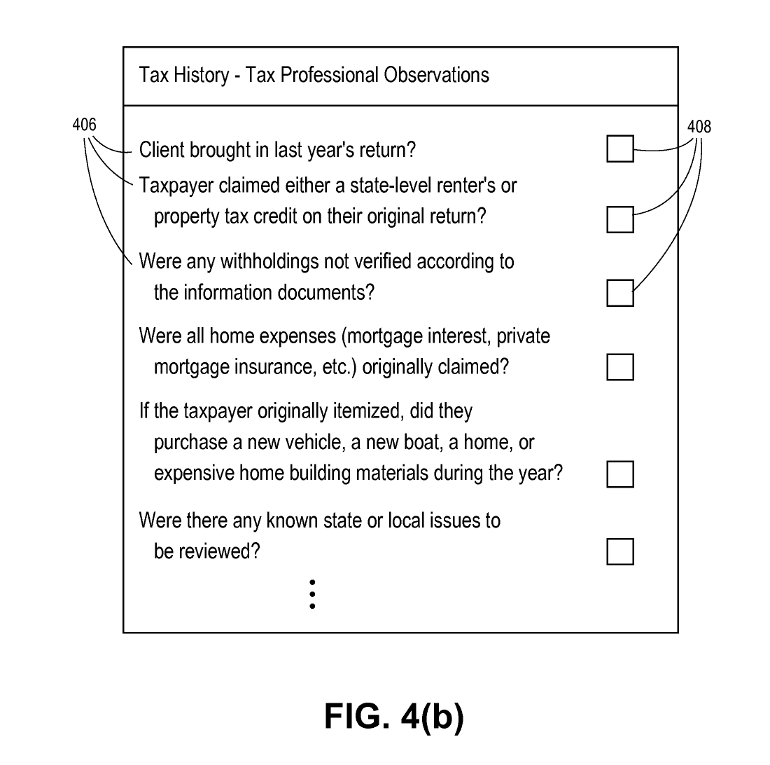

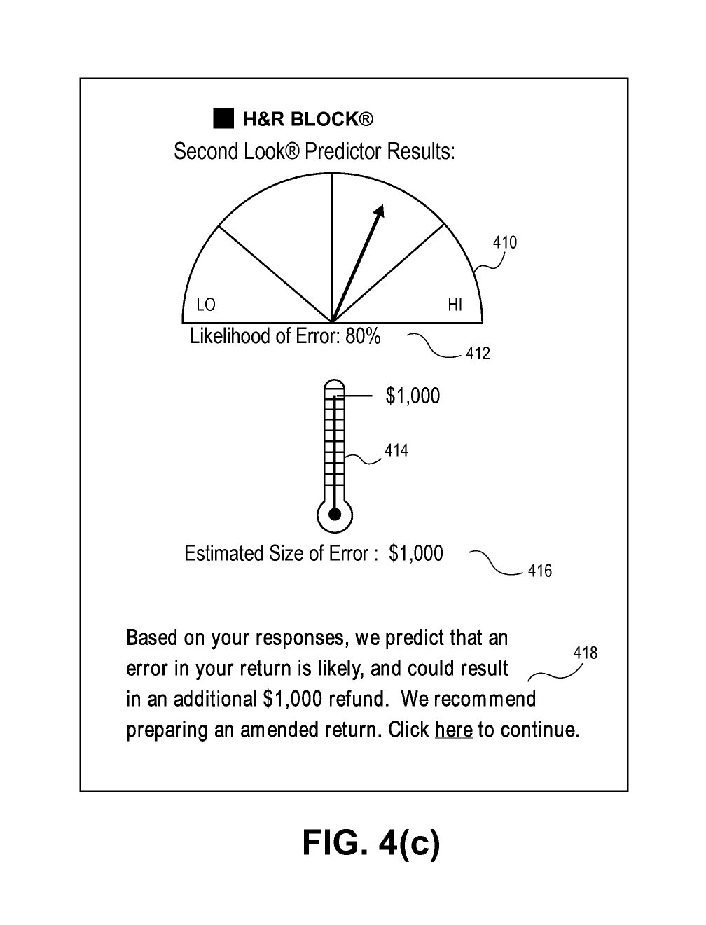

Turning now to FIGS. 4(a)-4(c), a series of views of a user interface is presented. FIG. 4(a) presents a view of the user interface for presenting a questionnaire to the taxpayer. In various embodiments, this questionnaire includes questions 402 directed to a household member of the taxpayer attending school, a failure to claim all dependents living in the taxpayer's household, a growth of the taxpayer's household, a debt forgiven, a large medical expense, a household member of the taxpayer engaged in military service, a source of foreign incoming requiring a payment of taxes in a foreign country, a source of retirement income, a member of the taxpayer's household having an individual taxpayer identification number, a self-employed member of the taxpayer's household, a source of rental property income, a farm owned by a member of the taxpayer's household, a lump-sum social security payment, and a letter received from the government taxing authority. In some embodiments, questions are phrased in yes-or-no form and a series of checkboxes 404 are provided for responses. In other embodiments, responses can be made in free form or numerical form and appropriate response fields are provided rather than checkboxes. In still other embodiments, a mix of question and response types is provided.

FIG. 4(b) depicts a view of the user interface for presenting a questionnaire to a tax professional. In some embodiments, this questionnaire is used in addition to the taxpayer questionnaire of FIG. 4(a). In other embodiments, it is used in place of the questionnaire of FIG. 4(a). In various embodiments, the questionnaire includes questions 406 directed to a state-level renter's tax credit claimed on the tax return, a state-level property tax credit claimed on the tax return, an unverified tax withholding, an unclaimed home expense, a vehicle purchase in combination with an itemized tax return, a home purchase in combination with an itemized tax return, a known state tax issue, and a known local tax issue. As with the taxpayer questionnaire of FIG. 4(a), in some embodiments, questions are phrased in yes-or-no form and a series of checkboxes 408 are provided for responses, while in other embodiments, responses can be made in free form or numerical form and appropriate response fields are provided rather than checkboxes, and in still other embodiments, a mix of question and response types is provided.

FIG. 4(c) depicts a view of the user interface for presenting the user with the results and the recommendation. In some embodiments, the likelihood of error is included in the results screen. In some such embodiments, the likelihood error is presented in graphical form 410. In other such embodiments, the likelihood of error is presented in textual form 412. In still other such embodiments, results are presented in both graphical form 410 and textual form 412. In some embodiments, the expected magnitude of error is instead (or in addition) included in the results screen. As with the likelihood of error, the estimated magnitude of error can be presented in graphical form 414, textual form 416, or both. In other embodiments, the error score is presented instead of (or in addition to) the likelihood of error and/or the expected magnitude of error. In some embodiments, the results screen also includes a recommendation 418 as to whether to file an amended return. In some such embodiments, provision is made for assisting the user in completing the amended return in addition to (or as a part of) recommendation 418.

Many different arrangements of the various components depicted, as well as components not shown, are possible without departing from the scope of the claims below. Embodiments of the invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims. Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A non-transitory computer readable storage medium having a computer program stored thereon for providing an error score for a taxpayer's previously filed tax return, wherein the computer program instructs at least one processing element to perform the steps of:
generating a questionnaire predictive of at least one error generally associated with tax returns filed with a government taxing authority;
presenting, to a user, the questionnaire for input by the user of at least one response indicative of a tax history of the taxpayer;
receiving an input, from the user, of at least one response;
providing, to a prediction engine, the at least one response received from the user; and
receiving, from the prediction engine, an error score for the taxpayer's previously filed tax return based on the at least one response received from the user.

2. The computer readable storage medium of claim 1, wherein the user is the taxpayer or a tax professional acting on behalf of the taxpayer.

3. The computer readable storage medium of claim 1, wherein the error score is determined based on a likelihood of error associated with the taxpayer's return.

4. The computer readable storage medium of claim 1, wherein the error score is determined based on an expected magnitude of error associated with the taxpayer's tax return.

5. The computer readable storage medium of claim 1, wherein the computer program further instructs the at least one processing element to perform a step of advising the user on correction of the taxpayer's tax return based on the determined error score associated with the taxpayer's tax return.

6. The computer readable storage medium of claim 5, wherein the step of advising the user on correction of the taxpayer's tax return comprises the substeps of:
determining that the error score is above a predetermined threshold indicating a likely tax liability on behalf of the taxpayer, such that the taxpayer owes the at least one government taxing authority a monetary amount; and
advising the taxpayer to have an amended tax return prepared and filed.

7. The computer readable storage medium of claim 5, wherein the step of advising the user on correction of the taxpayer's tax return comprises the substeps of:
determining that the error score is above a predetermined threshold indicating a likely tax refund on behalf of the taxpayer, such that the taxpayer is owed by the at least one government taxing authority a monetary amount; and
advising the taxpayer to have an amended tax return prepared and filed.

8. The computer readable storage medium of claim 1, wherein the step of generating the questionnaire comprises the substeps of:
collecting tax-related information from a set of tax returns filed by a plurality of taxpayers;
applying multivariate analysis to the collected tax-related information to obtain a classifier and a set of indicators; and
generating a set of questions, each question corresponding to an indicator of the set of indicators.

9. The computer readable storage medium of claim 8, wherein the step of determining the error score comprises the substep of applying the classifier to the at least one response received from the user to determine a likelihood of error.

10. The computer readable storage medium of claim 1, wherein the step of generating a questionnaire comprises the substeps of:
determining if the tax return was prepared by either a tax professional or was self-prepared by the taxpayer;
generating a first set of questions corresponding to a first subset of the set of indicators if the tax return was prepared by a tax professional; and
generating a second set of questions corresponding to a second subset of the set of indicators if the tax return was self-prepared by the taxpayer.

11. The computer readable storage medium of claim 1,
wherein the previously filed tax return was for a tax year; and
wherein the presented plurality of indicators includes at least one indicator directed to a change in at least one tax law or a new tax law that initially went into effect in the tax year.

12. The computer readable storage medium of claim 1, wherein the questionnaire includes questions relating to at least three of the set consisting of:
a household member of the taxpayer attending school;
a failure to claim all dependents living in the taxpayer's household;
a growth of the taxpayer's household;
a debt forgiven;
a large medical expense;
a household member of the taxpayer engaged in military service;
a source of foreign incoming requiring a payment of taxes in a foreign country;
a source of retirement income;
a member of the taxpayer's household having an individual taxpayer identification number;
a self-employed member of the taxpayer's household;
a source of rental property income;
a farm owned by a member of the taxpayer's household;
a lump-sum social security payment; and
a letter received from the government taxing authority.

13. The computer readable storage medium of claim 1, wherein the questionnaire includes questions relating to at least one of the set consisting of:
a state-level renter's tax credit claimed on the tax return;
a state-level property tax credit claimed on the tax return;
an unverified tax withholding;
an unclaimed home expense;
a vehicle purchase in combination with an itemized tax return;
a home purchase in combination with an itemized tax return;
a known state tax issue; and
a known local tax issue.

14. A system for providing an error score for a taxpayer's previously filed tax return, comprising:
at least one data store storing a first set of tax-related data known to be associated with erroneous returns;
a prediction engine comprising:
a statistical analyzer, operable to receive data from the data store and generate a questionnaire, and
an error score calculator associated with the questionnaire;
at least one display operable to display the questionnaire and an output of the prediction engine;
an input device, operable to receive a user's responses to the questionnaire and pass the responses to the error score calculator; and
wherein the error score calculator calculates an error score based on the user's responses to the questionnaire.

15. The system of claim 14, wherein the error score calculator comprises a classifier and a magnitude estimator.

16. The system of claim 14, wherein the prediction engine further comprises a recommendation engine operable to receive an error score from the error score calculator and advise the user on preparing an amended tax return based on the error score.

17. The system of claim 14, wherein the at least one data store further stores a second set of tax-related data associated with returns not known to be erroneous.

18. A method of predicting an error in a previously filed tax return, comprising the steps of:
receiving tax-related data associated with a plurality of erroneous tax returns;
compiling, based on the tax-related data associated with the plurality of erroneous returns, a plurality of indicators indicating an increased likelihood of error in an associated tax return;
generating, by a prediction engine, a questionnaire based on at least a portion of the plurality of indicators and an error score calculator associated with the questionnaire;
presenting the questionnaire to a user;
receiving tax-related data from the user responsive to the questionnaire;
passing the tax-related received from the user data to the prediction engine;
receiving from the prediction engine an error score for a tax return associated with the tax-related data received from the user; and
presenting to the user a recommendation as to preparing an amended return based on the error score.

19. The method of claim 18, further comprising the step of receiving tax-related data associated with a plurality of returns not known to be erroneous, and wherein compiling the plurality of indicators is further based on the tax-related data associated with the plurality of returns not known to be erroneous.

20. The method of claim 19, wherein the indicators are compiled by applying multivariate analysis to the tax-related data associated with the plurality of erroneous returns and the tax-related data associated with the plurality of returns not known to be erroneous.
